(19) United States
(12) Patent Application Publication
(10) Pub. No.: US 2025/0233429 A1
(43) Pub. Date: Jul. 17, 2025

(54) ELECTRIC VEHICLE CHARGER CAPABLE OF STABLY CHARGING ELECTRIC VEHICLES HAVING MUTUAL POTENTIAL DIFFERENCES

(71) Applicant: MODERNTEC CO., LTD., Gyeongsangnam-do (KR)

(72) Inventor: SEONG DOO KIM, Gyeongsangnam-do (KR)

(21) Appl. No.: 18/982,121

(22) Filed: Dec. 16, 2024

(30) Foreign Application Priority Data
Jan. 16, 2024 (KR) 10-2024-0006400

(51) Int. Cl. H02J 7/00; B60L 53/66

(52) U.S. Cl. CPC H02J 7/0031; B60L 53/66

(57) ABSTRACT

An electric vehicle charger includes power modules which converts alternating current into direct current and which has mutual potential differences, a distribution blocking part blocking or allowing a current flowing through an electric power line between the power modules in which outputs thereof are to be linked, a circuit breaker blocking a current flowing from the power modules to an electric vehicle connected to the electric power line, and a controller configured to control each operation of the power modules, the distribution blocking part, and the circuit breaker, the controller acquiring information on, before a current of other power modules is blocked or allowed, whether each of the power modules is individually a high or low voltage power module or information on whether at least one electric vehicle is being charged by at least one of the power modules.

### CROSS-REFERENCE TO RELATED APPLICATION AND CLAIM OF PRIORITY

This application claims the benefit under 35 USC § 119 of Korean Patent Application No. 10-2024-0006400, filed on Jan. 16, 2024, in the Korean Intellectual Property Office, the entire disclosure of which is incorporated herein by reference for all purposes.

### BACKGROUND

### 1. Technical Field

The present disclosure relates to an electric vehicle charger capable of simultaneously charging a plurality of electric vehicles having mutual potential differences and capable of stably charging the plurality of electric vehicles by preventing fire, failure, and so on.

### 2. Description of the Related Art

As the electric vehicle market is becoming more active and electric vehicles with various electric power capacities and various voltages are introduced, safety when an electric vehicle is charged by using an electric vehicle charger is required.

Basic safety when an electric vehicle is charged is guaranteed by the electric vehicle, but a fundamental safety measure for realizing safe charging of the electric vehicle may be required in an electric vehicle charger.

Conventionally, there are a plurality of methods for simultaneously charging a plurality of electric vehicles in a charging station including a distribution panel that receives electricity and distributes the electricity for each load, a server that stores charging electric power quantity and charging time information, and a control device for multiple charging configured as a main charger and a sub-charger for charging electric vehicles. However, for charging electric vehicles with different types of charging voltages that have potential differences are rarely found.

### SUMMARY

Accordingly, the present disclosure has been made keeping in mind the above problems occurring in the related art, and an objective of the present disclosure is to provide an electric vehicle charger capable of stably charging electric vehicles even when the electric vehicles have mutual potential differences.

According to the present disclosure, there is provided an electric vehicle charger including: a plurality of power modules configured to convert alternating current (AC) supplied from an electric power system into direct current (DC) for electric vehicle charging, the plurality of power modules having mutual potential differences; a distribution blocking part configured to block or allow a current flowing through an electric power line between the power modules in which outputs thereof are to be linked; a circuit breaker configured to block a current flowing from the power modules to an electric vehicle connected to the electric power line for charging; and a controller configured to control each operation of the power modules, the distribution blocking part, and the circuit breaker, the controller being configured to acquire information on, before a current of other power modules is blocked or allowed by the distribution blocking part, whether each of the power modules is individually a high voltage power module or a low voltage power module or information on whether at least one electric vehicle is being charged by at least one of the power modules.

Due to the diversification of electric vehicles, not all electric vehicles are charged at the same voltage when the electric vehicles are charged. Therefore, in a situation in which an electric vehicle that is charged at a high voltage and an electric vehicle that is charged at a low voltage are simultaneously charged, when a high voltage of about 800 V flows to the low voltage electric vehicle, problems such as a fire or a failure may occur. As part of a fundamental safety measure in such an electric vehicle charger, the present disclosure may provide an electric vehicle charger and a control method of the electric vehicle charger capable of safely charging a low voltage electric vehicle and a high voltage electric vehicle simultaneously.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is an explanatory view illustrating configurations of a power module, a distribution blocking part, a circuit breaker, and a measuring instrument of the present disclosure;

FIG. 2A to 2D are views illustrating embodiments of charging situations between high/low voltage power modules and high/low voltage electric vehicles;

FIG. 3 is an explanatory view illustrating a large electric power charging method utilizing a plurality of power modules of the present disclosure;

FIG. 4 is a view illustrating a structure and a control method of an electric vehicle charger of the present disclosure, the electric vehicle charger being configured such that high voltage electricity is prevented from flowing into a low voltage electric vehicle;

FIG. 5 is an explanatory view showing a control process of the electric vehicle charger of the present disclosure;

FIG. 6 is an explanatory view showing another embodiment of the control process in FIG. 5;

FIG. 7 is an explanatory view illustrating a method of turning off the distribution blocking part in order to solve a problem that occurs simultaneous charging of electric vehicles having mutual potential differences is performed;

FIG. 8 is an explanatory view illustrating another embodiment of the method in FIG. 7, and illustrates a method of maintaining the power module in a turned-off state in order to solve a problem that occurs when simultaneous charging of electric vehicles having mutual potential differences is performed; and

FIG. 9A and FIG. 9B are explanatory views showing an output reduction process and a charging finishing process of the electric vehicle charger of the present disclosure.

### DETAILED DESCRIPTION

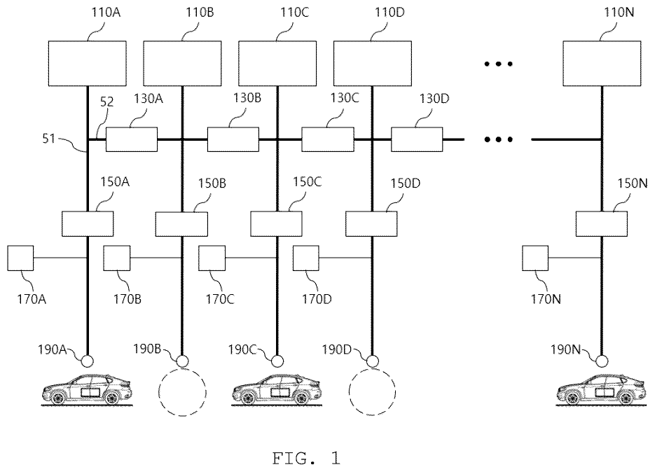

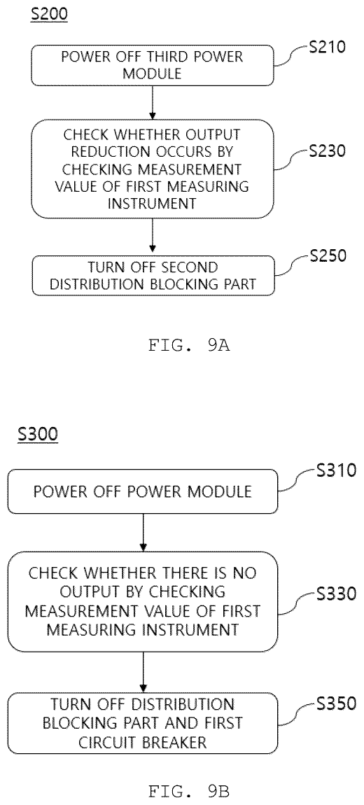

Referring to FIG. 1 to FIG. 9B, an electric vehicle charger of the present disclosure will be described.

In FIG. 1, an electric vehicle charger of the present disclosure may include at least one of a power module 110, a distribution blocking part 130, a circuit breaker 150, a measuring instrument 170, a connection part 190, and a controller. These components may be included in one electric vehicle charger, or may be separated and included in a plurality of electric vehicle chargers.

The power module 110 may be an electric power conversion part configured to convert alternating current (AC) supplied from an electric power system into direct current (DC) for electric vehicle charging. Electric power or voltage of each power module 110 may be set differently according to a place where the electric vehicle charger is mounted. A charger mounted for a personal home may be configured with only a plurality of low voltage power modules having a predetermined same electric power, and a charger mounted in an electric bus parking lot may be configured with only a plurality of high voltage power modules having the predetermined electric power. The electric vehicle charger of the present disclosure may be configured such that the electric vehicle charger is capable of charging both a low voltage electric vehicle such as an electric car and a high voltage electric vehicle such as an electric bus, an electric trailer, and so on. Furthermore, the main objective of the electric vehicle charger of the present disclosure is to realize safe charging ensuring that electricity from a high voltage power module does not flow into a low voltage electric vehicle even when simultaneous charging is performed, thereby being capable of preventing a problem such as fire, failure, and so on.

The distribution blocking part 130 is provided on a parallel electric power line 52 that links each power module 110 to each other, and may block or allow a current flowing between the plurality of power modules 110.

The circuit breaker 150 is provided on a series electric power line 51 that connects the power module 110 to an electric vehicle EV, and may be configured to block not only a current of a power module 110B that is additionally linked but also a current of the power module 110A that is connected in series with the connection part 190 to which the electric vehicle EV is connected.

The measuring instrument 170 may be provided adjacent to the connection part 190, and may measure or collect electric power data such as a current, a voltage, electric power, and so on of electricity flowing from the connection part 190 to the electric vehicle EV that is being charged.

The connection part 190 may be a coupler inserted into the electric vehicle EV when charging of the electric vehicle EV is performed. Furthermore, a plurality of connection parts 190 may be linked to each other according to a charging request specification of the electric vehicle EV and an electric power conversion capacity of the power module 110, and may be connected to a charging cable and a coupler.

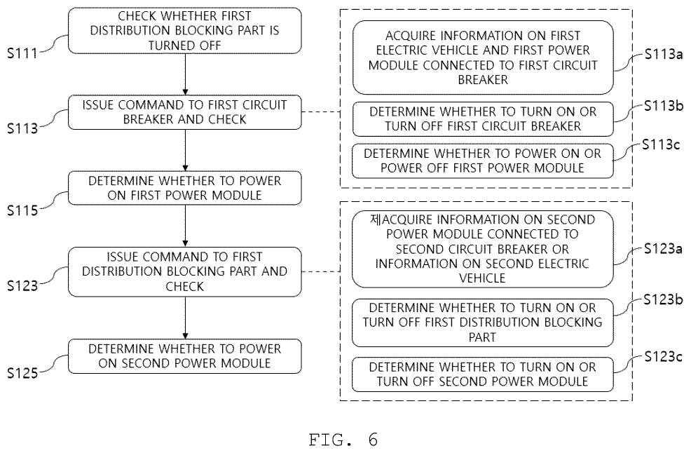

The controller may control a series of operations of the electric vehicle charger, the series of operations including charging. The controller may determine whether the power module 110, the distribution blocking part 130, or the circuit breaker 150 are operated to be turned on or turned off, and may command a control order of the components of the charger in FIG. 5 and FIG. 6.

One of the main objectives of the present disclosure is to prevent a problem that occurs when the electric vehicles EV that respectively require a plurality of different voltages on a single charger are simultaneously charged. Therefore, although it is described in the present disclosure that the plurality of power modules 110 is included in one charger, the description of the present disclosure is not limited thereto, and the description of the present disclosure may include a case in which the plurality of chargers and dispensers form an electric power line 50 grid with the power modules 110.

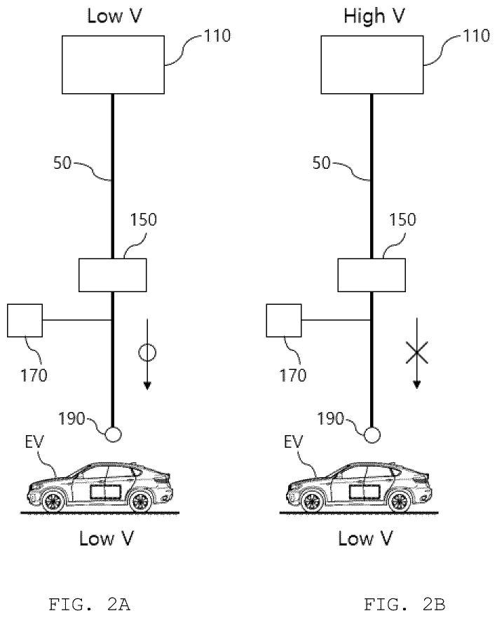

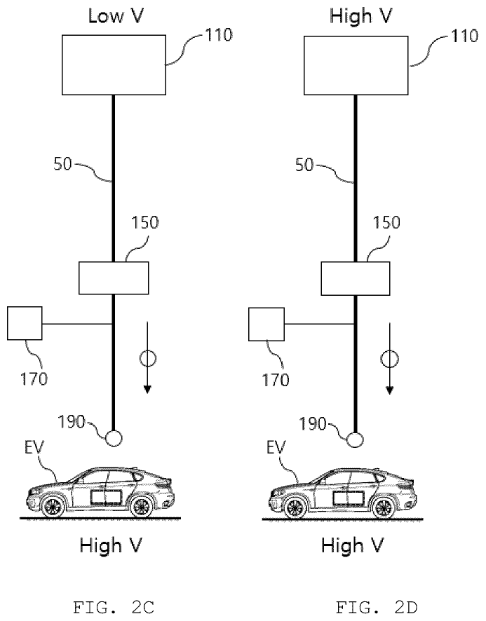

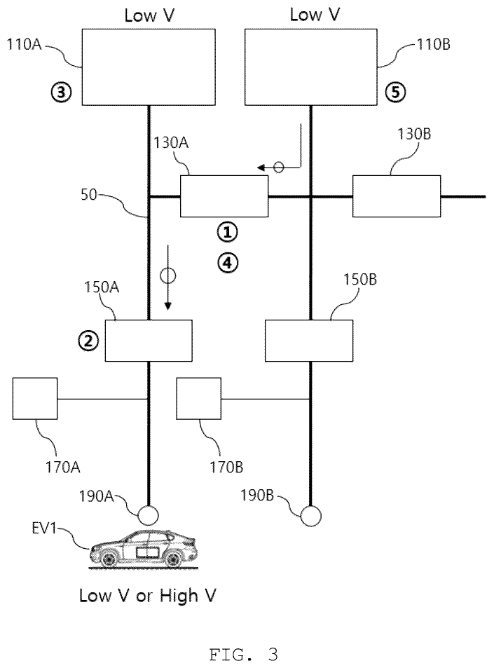

FIG. 2A to FIG. 2D are views illustrating a relationship between an electric power conversion part or the power module 110 and the electric vehicle EV, wherein the power module 110 is configured to output a low voltage (Low V) or a high voltage (High V) and the electric vehicle EV is configured to be charged with the Low V or the High V during charging or to request charging to the electric vehicle charger. Hereinafter, the power modules and the electric vehicles may be briefly described as a low voltage power module, a high voltage power module, a low voltage electric vehicle, and a high voltage electric vehicle.

As such, the electric vehicle charger of the present disclosure may charge all electric vehicles that require a charging voltage of various ranges, and may safely charge the electric vehicles without a risk of fire and so on even when the electric vehicles having mutual potential difference are simultaneously charged. For example, the low voltage electric vehicle may be a general electric car and so on, and a high voltage electric vehicle may be an electric bus, an electric cargo vehicle, and so on. When the high voltage electric vehicle is charged, the high voltage electric vehicle may require a voltage and electric power of at least several times more than a voltage and electric power that the low voltage electric vehicle requires. For example, the electric vehicle charger may charge all electric vehicles having a voltage range of 350 V to 850 V.

FIG. 2A to FIG. 2D may illustrate the simplest charging state in which there is no electric power line 50 connecting the power modules 110 to each other in parallel or there is no distribution blocking part 130 which is provided on the parallel connection electric power line 50 and which is configured to determine whether to block the flow of electricity/electric power and so on.

Even when the high voltage electric vehicle (High V EV) is connected to any one of the low voltage power module (illustrated in FIG. 2C) and the high voltage power module (illustrated in FIG. 2D) and the High V EV is not charged at an optimized charging speed, there may be no problem with the charging itself.

On the other hand, when the low voltage electric vehicle (Low V EV) is connected to the low voltage power module as illustrated in FIG. 2A, the Low V EV is normally charged. However, when the Low V EV is connected to the high voltage power module as illustrated in FIG. 2B, there may be a risk of fire as well as a risk of a reduction in charging efficiency since the high voltage current flows to the Low V EV, and a failure of the Low V EV or the charger may occur.

As a result, in terms of charging safety, it may be necessary to prevent a situation in which the current of the high voltage power module 110 flows to the low voltage electric vehicle when the low voltage electric vehicle is charged. When there is no parallel electric power line that connects the power modules 110 to each other by a simple series connection, it may be sufficient to separately mark the couplers respectively connected to the high voltage electric vehicle and the low voltage electric vehicle.

However, as the voltage or the electric power required by the electric vehicle such as the electric car, the electric bus, and so on are diversified, an electric circuit that interlinks the power modules 110 to each other is required for the charger. In addition, in order to provide various charging methods such as fast charging, slow charging, smart charging, and so on, it is necessary for charging safety to connect the power modules 110 in parallel.

In the present disclosure, for safety during charging, the circuit breaker 150 may be provided on the electric power line 51 that connects the power module 110 to the electric vehicle EV in series, and the distribution blocking part 130 may be provided on the electric power line 52 that connects the power modules 110 in parallel. That is, the distribution blocking part 130 and the circuit breaker 150 may serve as a safety sensor and a safety device providing dual protection against problems such as a fire and so on.

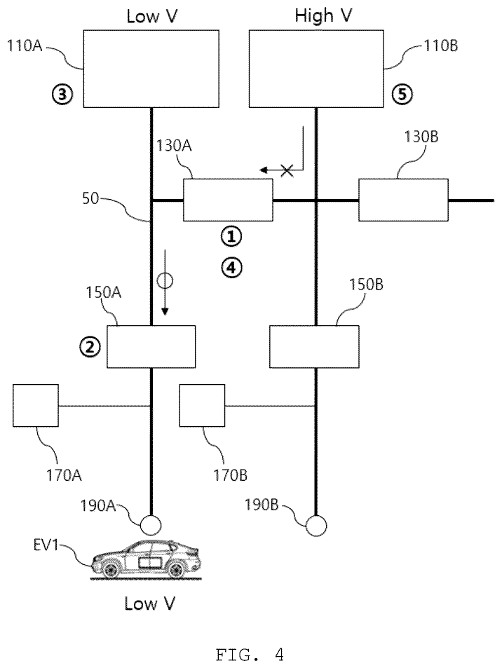

According to FIG. 3, a first electric vehicle EV1 which is a low voltage vehicle or a high voltage vehicle requests charging to the first power module 110A that is a low voltage power module (Low V), and the current of the second power module 110B that is the low voltage power module may be supplied to the first electric vehicle EV1 together with the current of the first power module 110A.

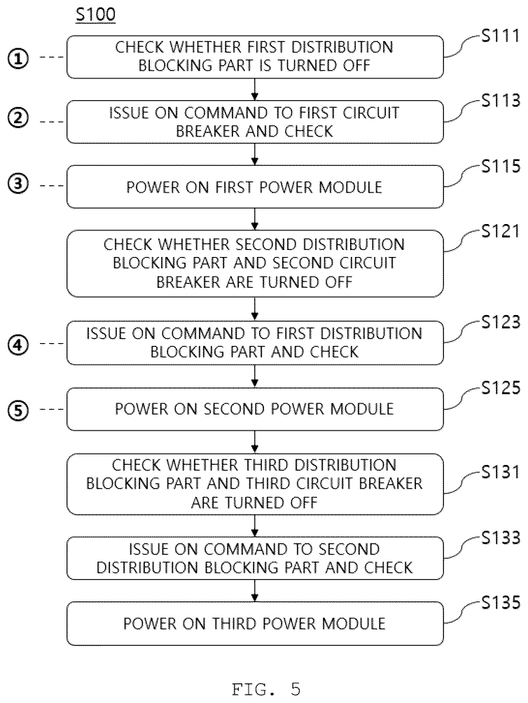

A control process S100 of the charger illustrated in FIG. 3 will be described in more detail with reference to FIG. 5 and FIG. 6. FIG. 5 is a view showing the control process S100 or a control method of the charger using the power module 110 capable of supplying the same voltage without a potential difference. \textcircled{1} \textcircled{2}, \textcircled{3}, \textcircled{4}, and \textcircled{5} that are illustrated in FIG. 5 may correspond to \textcircled{1}, \textcircled{2}, \textcircled{3}, \textcircled{4}, and \textcircled{5} that are illustrated in FIG. 3 and FIG. 4.

Before powering on the power module 110 which is assigned to the connection part 190 where the electric vehicle EV is connected thereto so as to be charged or which is connected to the connection part 190 in series, an operation state of the distribution blocking part 130 provided on the electric power line 50 that connects the power module 110 to another adjacent power module 110 or an operation state of the circuit breaker 150 provided on the series electric power line 51 may be first checked.

Checking of the operation state of the distribution blocking part 130 or the circuit breaker 150 may mean checking whether the distribution blocking part 130 or the circuit breaker 150 is in a turned-off state. Furthermore, the turned-off state of the distribution blocking part 130 or the circuit breaker 150 may refer to a state in which a current is blocked so that the current does not flow to the electric power line 50 where the distribution blocking part 130 and the circuit breaker 150 are mounted.

Before checking the operation state of the circuit breaker 150, the operation state of the distribution blocking part 130 may be checked first. This may be to first check that a current does not flow from the previously mentioned another power module 110 corresponding to another circuit breaker 150 before checking that a current does not flow along the electric power line connected in series with the power module 110 corresponding to the corresponding circuit breaker 150.

In FIG. 5 and FIG. 6, as an embodiment, a situation in which the first electric vehicle EV1 requests charging to a connection part 190A corresponding to the first power module 110A and electric power is supplied by the plurality of power modules that are linked to each other is described.

The controller may check that the current does not flow from the parallel electric power line 52 around a first distribution blocking part 130A by checking that the operation of the first distribution blocking part 130A is turned off S111.

The controller may issue an on command to the first circuit breaker 150A, and may check whether the first circuit breaker 150A is operating well S113.

When the circuit breaker 150 is turned on, the circuit breaker 150 may perform a blocking operation. Accordingly, when electricity having a value equal to or more than a predetermined threshold value such as a threshold voltage value and so on flows to the electric power line 50 where the circuit breaker 150 is mounted, the circuit breaker 150 is automatically operated so that electricity does not flow therethrough. Ensuring that the controller checks the distribution blocking part 130 or the circuit breaker 150 may include a meaning of checking a sensor that prevents electricity having a value equal to or more than an allowable current and an allowable voltage to flow therethrough. The distribution blocking part 130 and the circuit breaker 150 may function as two safety devices for preventing a high voltage current from flowing into a low voltage electric vehicle.

The controller may power on the first power module 110A, and electric power may be supplied from the first power module 110A to the first electric vehicle EV1 S115.

By checking whether an operation of a second distribution blocking part 130B or a second circuit breaker 150B is turned off, whether electric power is supplied to the first electric vehicle EV1 via the first distribution blocking part 130A is capable of being checked S121.

The S121 process may be applied when at least three power modules are required for charging the first electric vehicle EV1 for reasons such as rapid charging, electric power capacity, and so on.

The S121 process may be performed before the second power module 110B is powered on S125, or may be performed before a third power module 110C is powered on S135.

By performing the S121 process before the second power module 110B is powered on S125 or before the third power module 110C is powered on S135, whether the electricity output from the second power module 110B or the third power module 110C flows to the first electric vehicle EV1 through the second distribution blocking part 130B or through the electric power line where the second distribution blocking part 130B is provided is capable of being checked.

The controller may issue an on command to the first distribution blocking part S123. The S123 process may be performed before receiving electricity from the second power module 110B or before the second power module 110B is powered on S125.

The output of the second power module 110B may be supplied to the first electric vehicle EV1 along with the output of the first power module 110A.

A process in the same manner as the process on the second power module 110B may be performed on the third power module 110C.

The controller may check whether an operation state of a third distribution blocking part 130C or a third circuit breaker 150C is turned off S131. In this process S131, whether the electric power of a fourth power module 110D and so on is not supplied from the fourth power module 110D and so on through the third distribution blocking part 130C or through an electric power line where the third distribution blocking part 130C is mounted is capable of being checked.

The controller may issue an on command to the second distribution blocking part 130B, and may check whether the second distribution blocking part 130B is turned on.

The controller may issue an on command to the third power module 110C so that the third power module 110C is powered on, and the electric power of the third power module 110C may be supplied to the first electric vehicle EV1.

The description mentioned above may be related to a case in which the first electric vehicle EV1 is charged by linking each electric power of the three power modules 110A, 110B, and 110C. In addition, the process of using the three power modules may be a charging linkage process between the power modules that do not have mutual potential differences between each other due to high voltage or low voltage (see FIG. 3).

When a potential difference occurs between the power modules (see FIG. 4), information on whether each of the power modules is individually a high voltage power module or a low voltage power module, information on whether the electric vehicle is being charged by another power module 110, and so on are required to be acquired before performing an operation of allowing or blocking the electric power of the previously mentioned another power module, rather than immediately issuing the on command to the circuit breaker 150 or the distribution blocking part 130. In this case, the meaning of the issuance of the on command for the distribution blocking part 130 S123 or the meaning of the issuance of the on command for the circuit breaker 150 S113 may have an extended meaning.

According to FIG. 6, the command to the circuit breaker or the on command process S113 may include acquiring information about the power module 110 connected to the corresponding circuit breaker 130 and about the electric vehicle EV S113a, determining whether to turn on or turn off the corresponding circuit breaker 130 S113b, or determining whether to turn on or turn off the power module 110 connected to the corresponding circuit breaker 130.

In the S113b process, when electricity flows to the electric power line 50 where the circuit breaker 130 is mounted and the electricity exceeds a set threshold value, the circuit breaker 130 may perform the blocking operation.

In the S113a process, when the electric vehicle EV is connected to the connection part 190 so as to be charged, information of the electric vehicle EV may be transmitted to the controller along the electric power line 50. When the electric vehicle EV is a low voltage electric vehicle and the power module 110 connected to the corresponding circuit breaker 130 is a high voltage power module (see FIG. 2B), there is a risk of fire or failure, so that the controller may not power on the power module 110 S113c. Therefore, in the S113a process, when a connection relationship (see FIG. 2A, FIG. 2C, and FIG. 2D) between the power module 110 and the electric vehicle EV is different from the connection relationship as in FIG. 2B, the controller may issue the on command to the circuit breaker S113b so that the power module 110 is powered on S113c.

In addition, the issuance of the command for the distribution blocking part 130 or the command process S123 may include acquiring information about another power module in which the output thereof is to be linked, about whether another electric vehicle is being charged by the corresponding another power module, or about the corresponding another electric vehicle when the corresponding another electric vehicle is being charged S123a, determining whether to turn on or turn off the distribution blocking part 130 S123b, and determining whether to turn on or turn off the previously mentioned another power module in which the output thereof is to be linked S123c.

The determining of whether to turn on or turn off the circuit breaker 150 may match the determining of whether to turn on or turn off the power module 110 connected to the corresponding circuit breaker 150. For example, when the first circuit breaker 150A is determined to be turned on, the first power module 110A may be determined to be turned on. Furthermore, when the first circuit breaker 150A is determined to be turned off, the first power module 110A may be determined to be turned off.

On the other hand, the determining of whether to turn on or turn off the distribution blocking part 130 S123b may match the determining of whether to turn on or turn off the previously mentioned another power module 110 in which the output thereof is to be linked S123c, but may be performed independently from each other. Whether another electric vehicle is being charged by another power module in which the output thereof is to be linked may affect a situation in which a determination result of the determining of whether to turn on or turn off the distribution blocking part 130 S123b and a determination result of the determining of whether to turn on or turn off the previously mentioned another power module 110 in which the output thereof is to be linked S123c differ from each other.

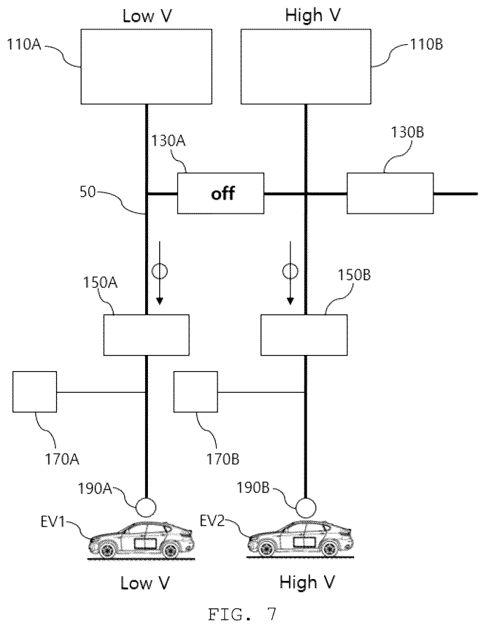

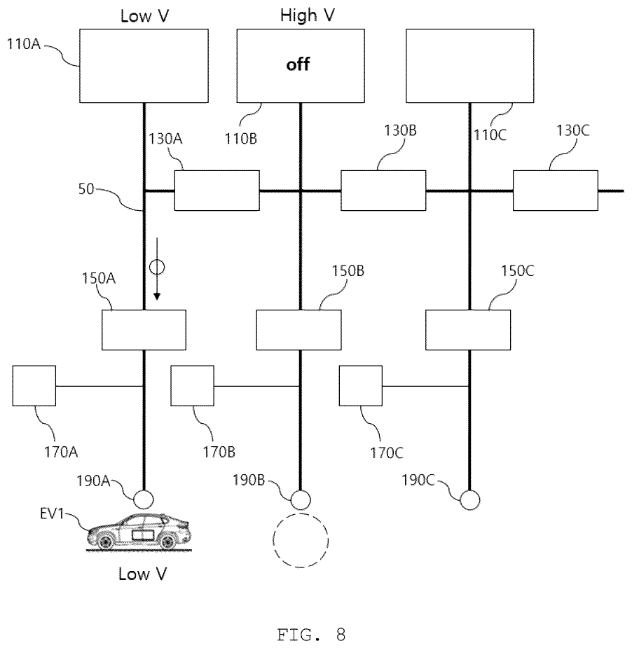

FIG. 7 and FIG. 8 are views illustrating a situation in which the first electric vehicle EV1 that is the low voltage vehicle requests charging by being connected to the first power module 110A that is the low voltage power module and electricity of the second power module 110B is prevented from being supplied to the first electric vehicle EV1 because the second power module 110B which is the high voltage power module and in which the output thereof is to be linked. FIG. 7 and FIG. 8 are common in that the current of the second power module 110B that is the high voltage power module is not supplied to the first electric vehicle EV1, but whether the distribution blocking part 130 is turned off (see FIG. 7) or whether the second power module 110B is turned off (FIG. 8) may vary.

In FIG. 7, in a situation in which a second electric vehicle EV2 is already being charged by the second power module 110B, the first distribution blocking part 130A may be turned off so as not to affect the turned-on state or turned-off state of the second power module 110B that is supplying electric power to the second electric vehicle EV2 during the output linkage process of the first electric vehicle EV1. However, in this situation, the output of another power module may not be linked to the first electric vehicle EV1.

On the other hand, in FIG. 8, in a situation in which another electric vehicle is not being charged by the second power module 110B, the controller may turn off the second power module 110B. In this situation, comparing to the situation in which the distribution blocking part 130 is turned off, there may be a difference in that an output of another power module such as the third power module 110C is capable of being linked.

The controller may reduce the electric power supplied to the electric vehicle EV for reasons such as switching from rapid charging to slow charging, nearing the completion time of charging, and so on S200.

The output reduction process S200 may include powering off another power module (for example, the third power module 110C) in which the output thereof is linked S210, checking whether there is an output reduction corresponding to the turning off of the third power module 110C by checking a measurement value of a first measuring instrument 170A, or turning off the second distribution blocking part S250.

The situation in which the output reduction process S200 is performed may be a situation when the first power module 110A to the third power module 110C are linked to each other and charge the first electric vehicle EV1 linked to the first circuit breaker 150A.

In order to further reduce the output, the second power module 110C may be powered off as in the S210 process, and the first distribution blocking part 130A may be turned off as in the S250 process.

When the charging is finished S300, all remaining power modules may be powered off S310, whether there is no electric power supplied to the first electric vehicle EV1 may be checked by checking the measurement value of the first measuring instrument 170A S330, and all remaining distribution blocking parts 130 and the first circuit breaker 150A may be turned off S350.

Every distribution blocking part 130 or every circuit breaker 150 operated for charging the electric vehicle EV is turned off by the method described above, so that it can be ensured that there is no leakage of current through the electric power line 50 grid. As a result, since the turned-off state is maintained until the distribution blocking part 130 and the circuit breaker 150 are turned on in the charging control process S100 according to the charging request, the electric power consumption may be reduced, and electricity of the high voltage power module may be prevented from flowing to the low voltage electric vehicle.

What is claimed is:

1. An electric vehicle charger comprising:
power modules configured to convert alternating current (AC) supplied from an electric power system into direct current (DC) for electric vehicle charging, the power modules having mutual potential differences;
a distribution blocking part configured to block or allow a current flowing through an electric power line between the power modules in which outputs thereof are to be linked;
a circuit breaker configured to block a current flowing from the power modules to an electric vehicle connected to the electric power line for charging; and
a controller configured to control each operation of the power modules, the distribution blocking part, and the circuit breaker, the controller being configured to acquire information on, before a current of other power modules is blocked or allowed by the distribution blocking part, whether each of the power modules is individually a high voltage power module or a low voltage power module or information on whether at least one electric vehicle is being charged by at least one of the power modules.

2. The electric vehicle charger of claim 1, wherein the electric power line comprises:
a first electric power line that connects the power modules to the electric vehicle in series; and
a second electric power line configured such that the outputs of each current between the power modules are linked,
wherein, when a first electric vehicle is charged through the first electric power line corresponding to a first power module, the controller is configured to first check an operation state of the distribution blocking part that links an output of a second power module to the first electric vehicle or an operation state of a first circuit breaker of the first electric power line before the controller powers on the first power module.

3. The electric vehicle charger of claim 1, wherein the controller is configured to first check an operation state of the distribution blocking part before the controller checks an operation state of the circuit breaker, and
the controller is configured to first check whether a current from other power modules does not flow before the controller checks whether a current flows along respective first electric power lines connected in series with the power modules respectively corresponding to each circuit breaker.

4. The electric vehicle charger of claim 1, wherein determining of whether to turn on or turn off the distribution blocking part is capable of being determined independently from determining of whether to turn on or turn off other power modules in which outputs thereof are to be linked, and
whether a determination result of the determining of whether to turn on or turn off the distribution blocking part and a determination result of the determining of whether to turn on or turn off the other power modules in which the outputs thereof are to be linked are differ from each other may be determined according to whether at least one electric vehicle is being charged by at least one of the other power modules.

5. The electric vehicle charger of claim 1, wherein, in a situation in which a first electric vehicle that is a low voltage electric vehicle requests charging by being connected to a first power module that is a low voltage power module, a second power module in which an output thereof is to be required to be linked is a high voltage power module, and a second electric vehicle is being charged by the second power module,
the controller is configured to turn off a first distribution blocking part so that electric power of the second power module is not supplied to the first electric vehicle.

6. The electric vehicle charger of claim 1, wherein, in a situation in which a first electric vehicle that is a low voltage electric vehicle requests charging by being connected to a first power module that is a low voltage power module, a second power module in which an output thereof is to be required to be linked is a high voltage power module, and another electric vehicle is not being charged by the second power module,
the controller is configured to turn off the second power module and to perform linkage of an output of a third power module that is different from the first power module and the second power module.

7. The electric vehicle charger of claim 1, wherein a first electric vehicle is configured to be charged through a first electric power line on which a first circuit breaker that corresponds to a first power module is provided,
a first distribution blocking part or a second distribution blocking part is provided on a second electric power line configured to transmit a current between the power modules,
the controller is configured to check whether the current from the second electric power line does not flow by checking whether an operation of the first distribution blocking part is turned off,
the controller is configured to issue an on command to the first circuit breaker, to power on the first power module, to issue an on command to the first distribution blocking part, and to power on a second power module, and
an output of the second power module is supplied to a first electric vehicle along with an output of the first power module.

8. The electric vehicle charger of claim 1, wherein the electric power line comprises:
a first electric power line that connects the power modules to the electric vehicle in series; and
a second electric power line configured such that the outputs of each current between the power modules are linked,
wherein the distribution blocking part is provided on the second electric power line, and the circuit breaker is provided on the first electric power line.

9. The electric vehicle charger of claim 1, further comprising:
a measuring instrument configured to measure electric power data supplied to the electric vehicle,
wherein, in a situation in which an electric power output supplied to the electric vehicle is reduced,
the controller is configured to power off the power modules in which the outputs thereof are linked, to check whether an output reduction corresponding to the powering off of the power modules in which the outputs thereof are linked occurs by checking a measurement value of the measuring instrument, and to turn off the distribution blocking part, and
in a situation in which charging of the electric vehicle is finished,
the controller is configured to power off remaining power modules, to check whether there is no electric power supplied to the electric vehicle by checking the measurement value of the measuring instrument, and to turn off remaining distribution blocking part and the circuit breaker.
